(19) United States
(12) Patent Application Publication
(10) Pub. No.: US 2012/0124774 A1
(43) Pub. Date: May 24, 2012

(54) Device At A Control Mechanism For A Window Fixture At A Turntable Window

(76) Inventor: Hans Öhman, Vastra Frolunda (SE)

(21) Appl. No.: 13/388,138

(22) PCT Filed: Jul. 23, 2010
(86) PCT No.: PCT/SE2010/050865

§ 371 Date: Jan. 31, 2012

(30) Foreign Application Priority Data
Jul. 31, 2009 (SE) 0950575-1
Oct. 16, 2009 (SE) 0950763-3

(51) Int. Cl. E05F 1/12; E05D 15/40

(52) U.S. Cl. 16/303; 16/382

(57) ABSTRACT

The invention relates to a device (1) at a window (2) that comprises a window pane (4) received in a window casement (3) with the casement (3) and the pane (4) receivable in a window frame (5), turnable 180° or more around a pivot bearing (8) and locked to the frame (5) by means of lock plungers (6, 7), which are receivable in guiding grooves (9, 10) in the casement (5). According to the invention, in each corner (A-D) of said frame (5), a control mechanism (11) is arranged for the regulation of the motion of said lock plungers (6, 7). A control (27) for the actuation of said lock plungers (6, 7) is arranged on the window (5) and the control mechanism (11) comprises a cam surface (14) that is co-operatable with a motion transfer part (19) for the lock plungers (6, 7). The window casement (3) is optionally openable at the top or bottom, turnable, angleable into the desired position as well as lockable by the actuation of controls (12 and 13, respectively; 27) therefor.

The present invention relates to a device at an openable window that comprises a window pane received in a window casement with the casement and the pane receivable in a window frame, turnable 180° or more around a pivot bearing formed of pivoting arms, and secured in the frame by means of a number of lock plungers, which are receivable in guiding grooves in the casement.

By U.S. Pat. No. 3,676,955 A, a control mechanism carried on the frame is known, but this mechanism does not comprise, among other things, lock plungers arranged according to the kind indicated and this known mechanism of the kind indicated has in addition undesirable thermal bridges through the frame as far as windows consisting of metal sections are concerned.

Accordingly, an essential object of the invention is to provide a solution that, among other things, solves said disadvantages and that also makes it possible to provide a mechanism that allows to obtain desired regulation of the window by optional actuation of the upper or lower mechanisms of the window and that is simple both as regards the design and function thereof.

An additional object is to provide opening independently of which side of the window casement that faces inward or outward and also to be able to handle large and heavy windows without any risk as well as that such windows are allowed to be efficiently closable without the same bend due to strong winds resulting in penetration of water and wind.

Said object, among others, is achieved by means of a device according to the present invention that essentially is characterized in that, in each corner of said frame, a control mechanism is arranged for the regulation of the motion of said lock plungers, that a control for the actuation of said lock plungers is arranged on the window frame, that the control mechanism comprises a cam surface, that said cam surface is co-operatable with a motion transfer part actuating said lock plungers, that said motion transfer part is movable in relation to said cam surface, whereby the window casement is optionally turnable and angleable, respectively, into the desired position as well as lockable by the actuation of said different controls therefor.

The invention is described below by way of a number of preferred embodiment examples, reference being made to the accompanying drawings, in which

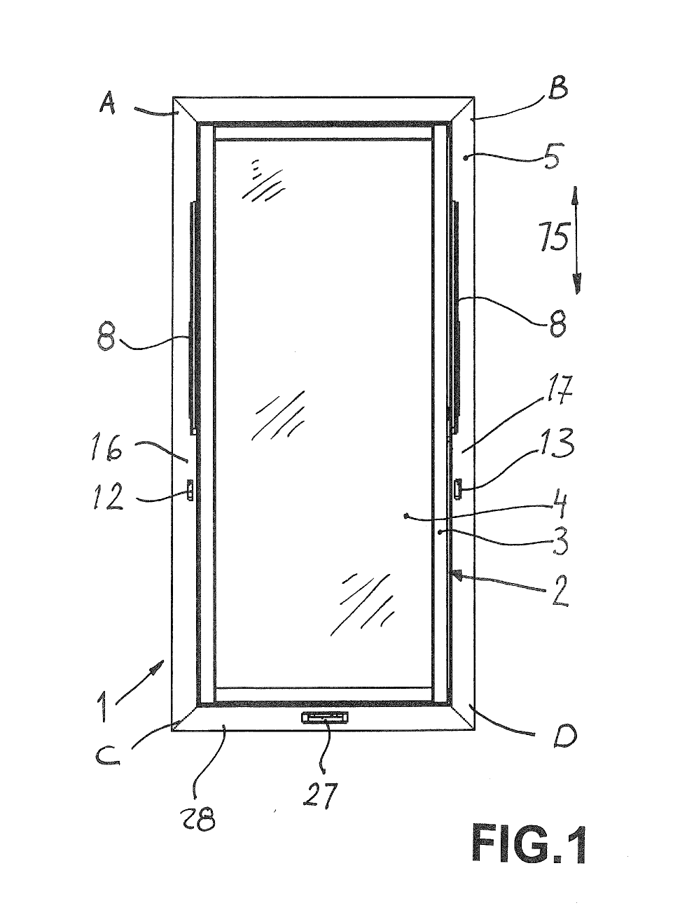

FIG. 1 shows a front view of a window according to the invention comprising control mechanism according to the invention,

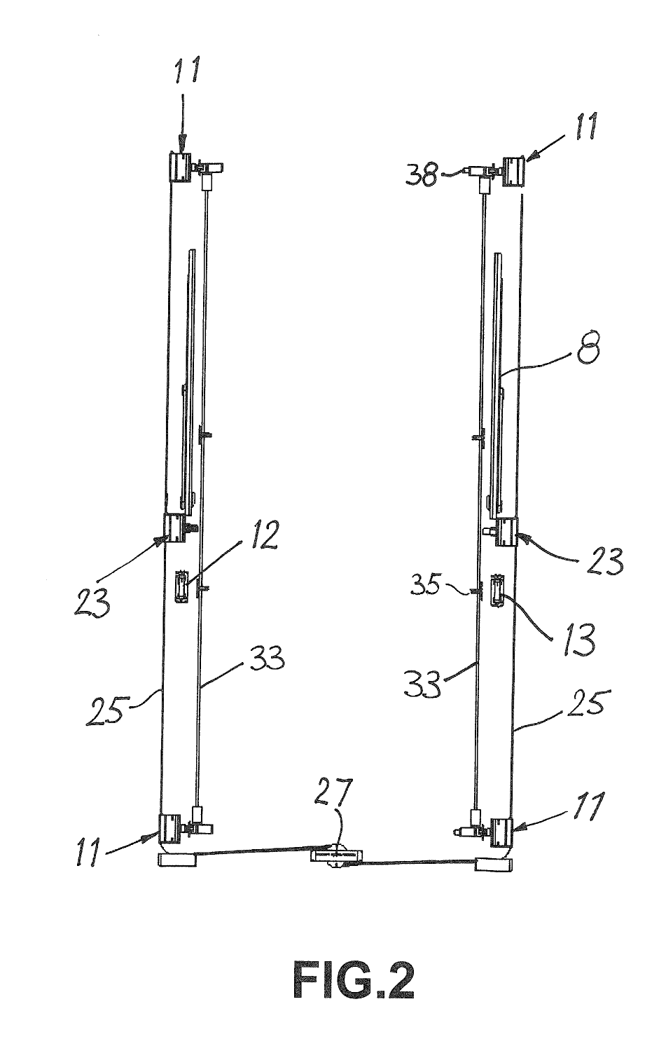

FIG. 2 shows a schematic front view of a window mechanism according to the invention,

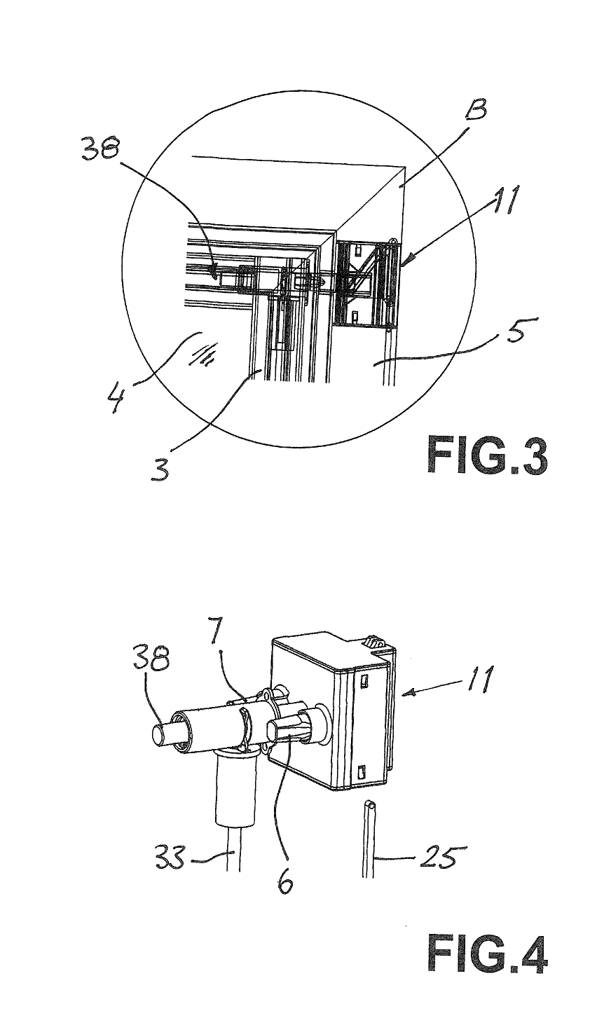

FIG. 3 shows a part of said control mechanism in cross-section,

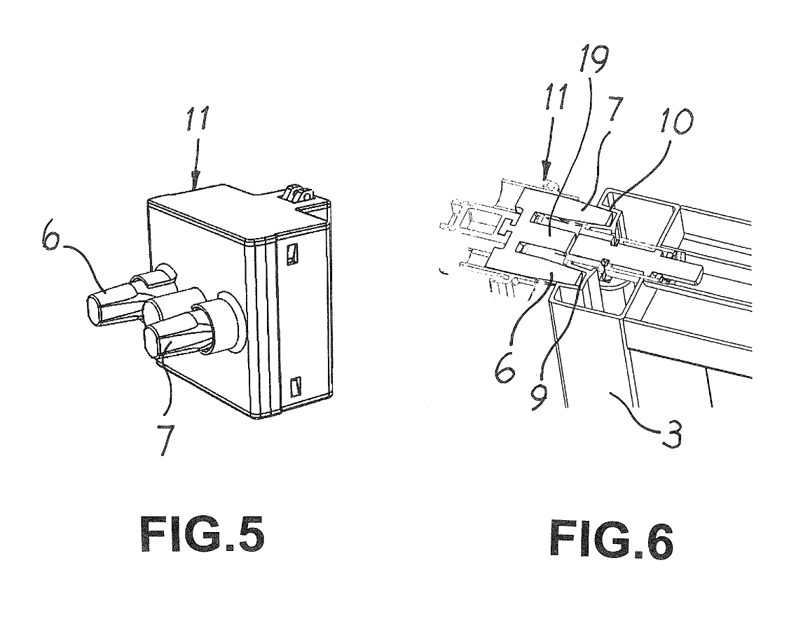

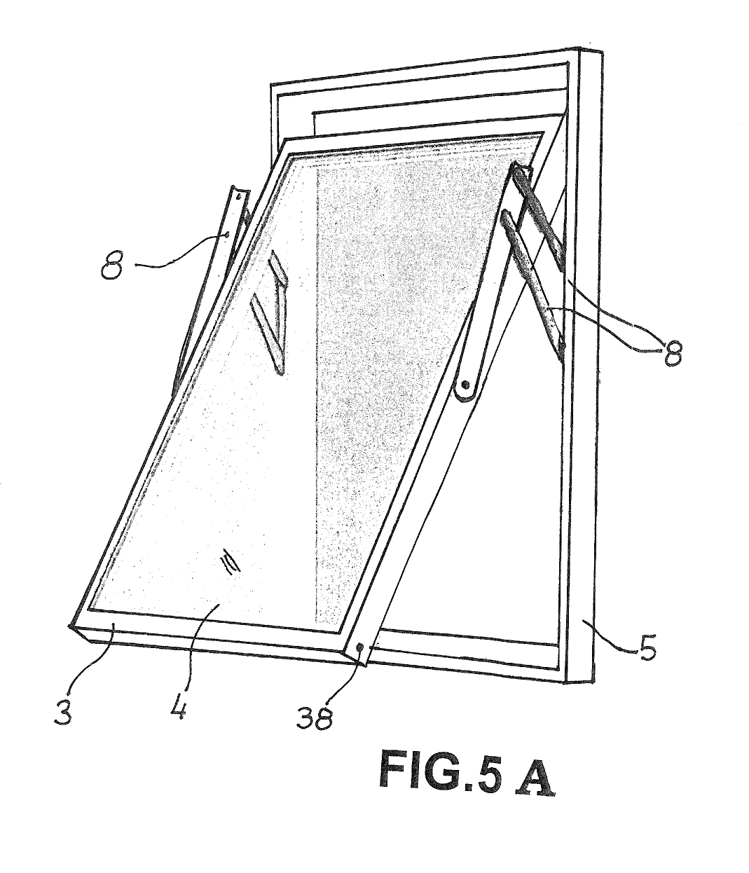

FIGS. 4-5 show in perspective a control mechanism,

FIG. 5A shows suspension arms of the casement of the window in shown open position,

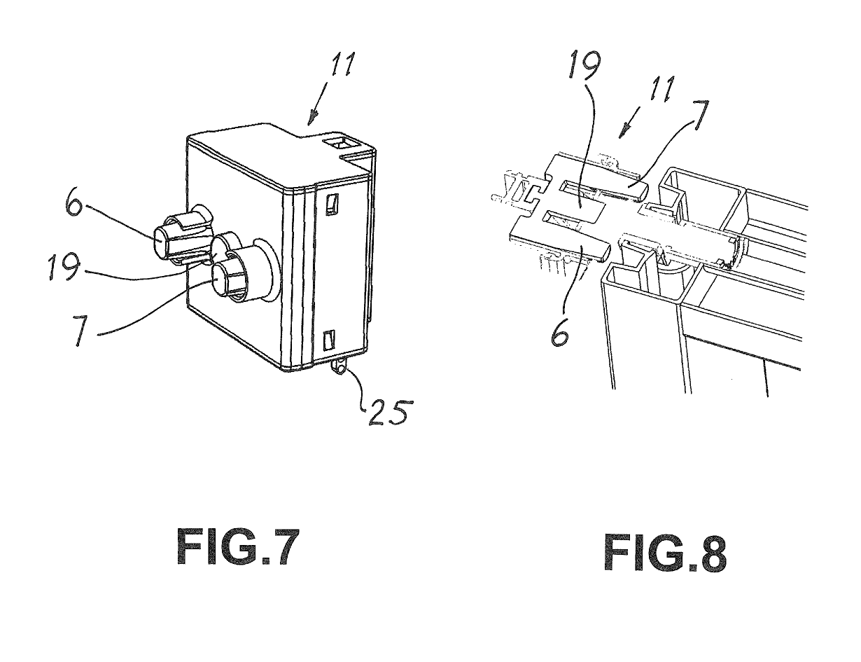

FIG. 6 shows parts included in the mechanism and their motions together with a part of a window,

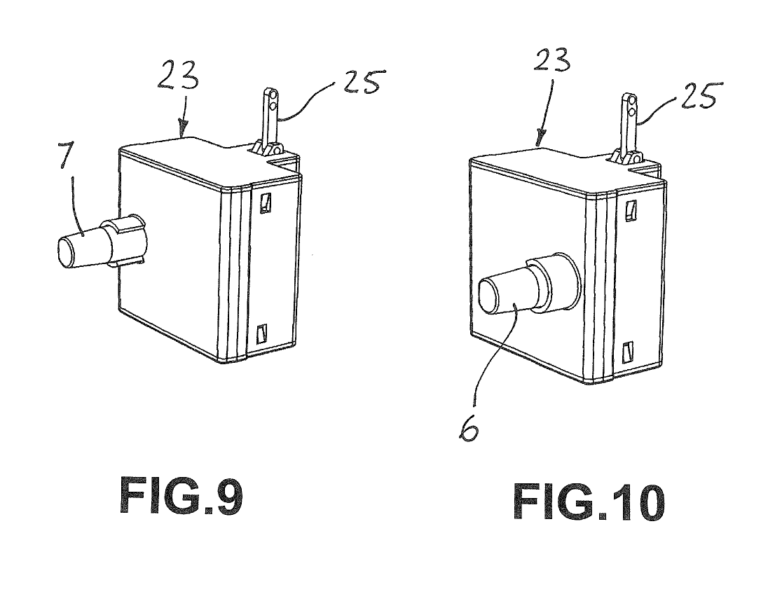

FIG. 7 shows in perspective a control mechanism mounted in each corner,

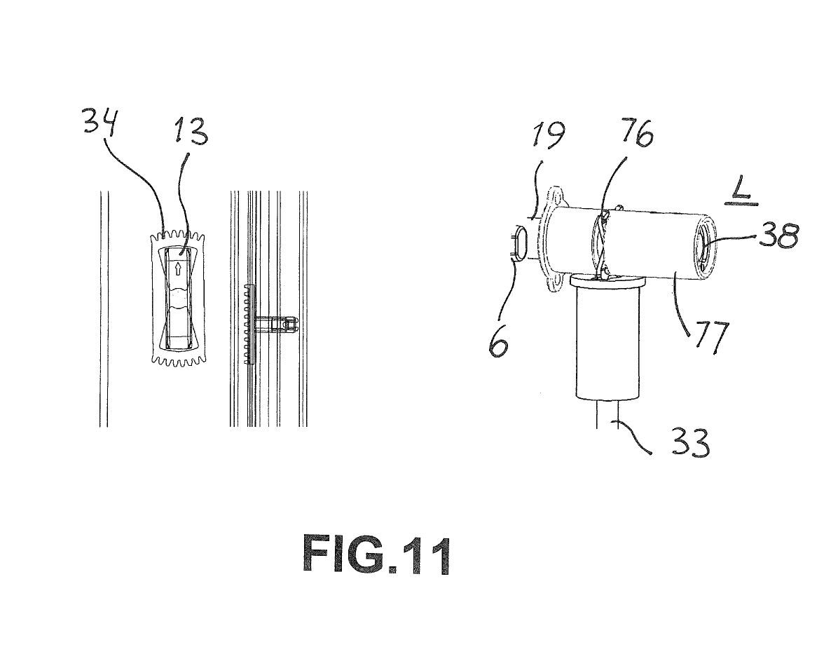

FIG. 8 shows pair-wise interconnected spring force actuatable lock plungers and the pair-wise simultaneous displacement motions thereof shown in the unlocked position of the window,

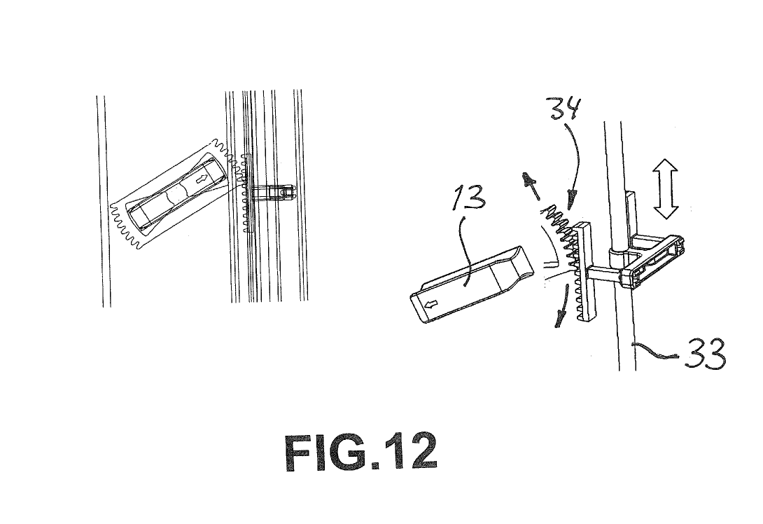

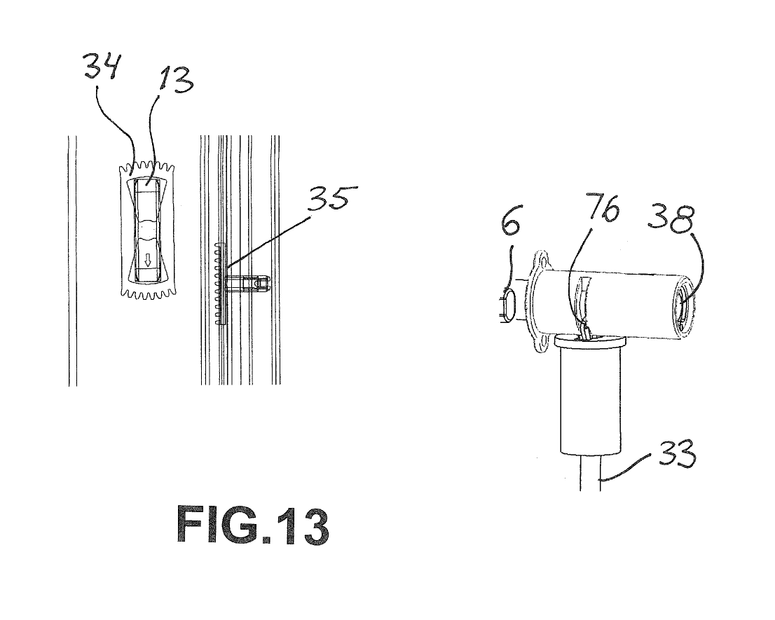

FIGS. 9-10 show the left and the right, respectively, intermediate mechanism in perspective including lock plunger in the projected position,

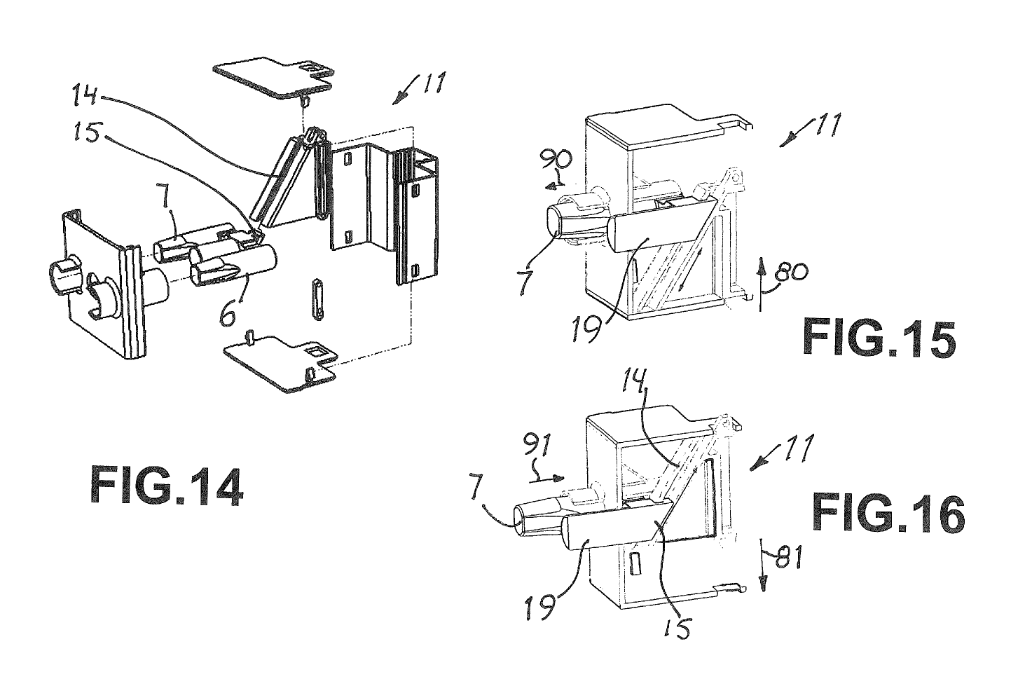

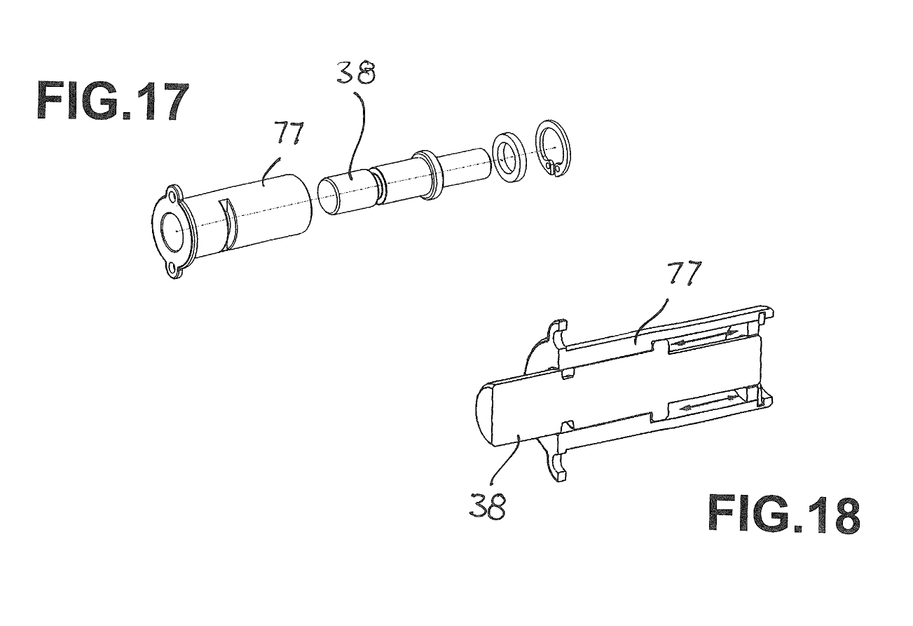

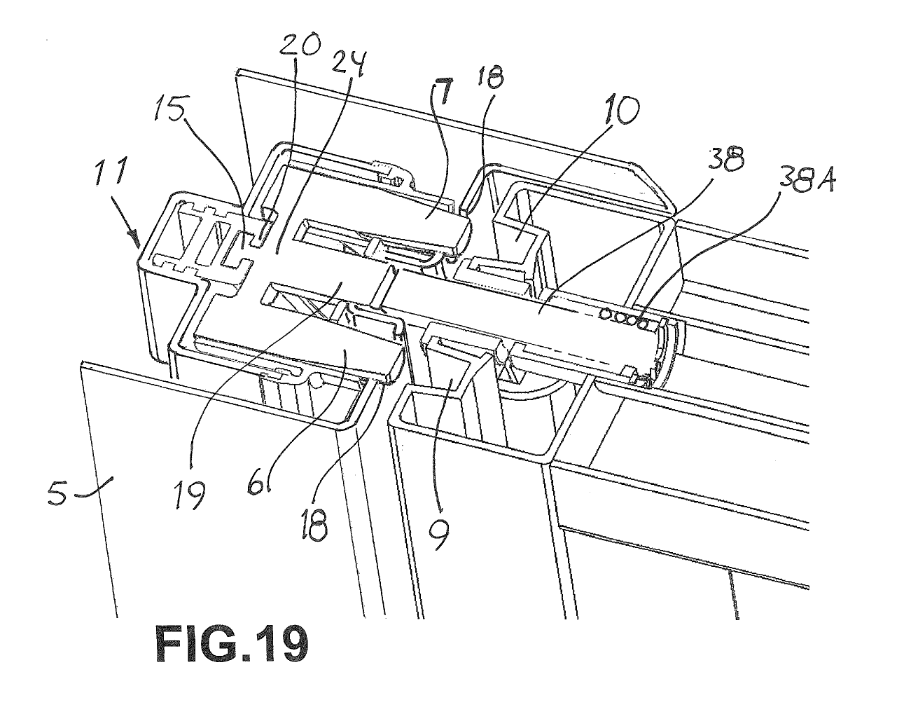

FIGS. 11-13 show locking controls in different positions,

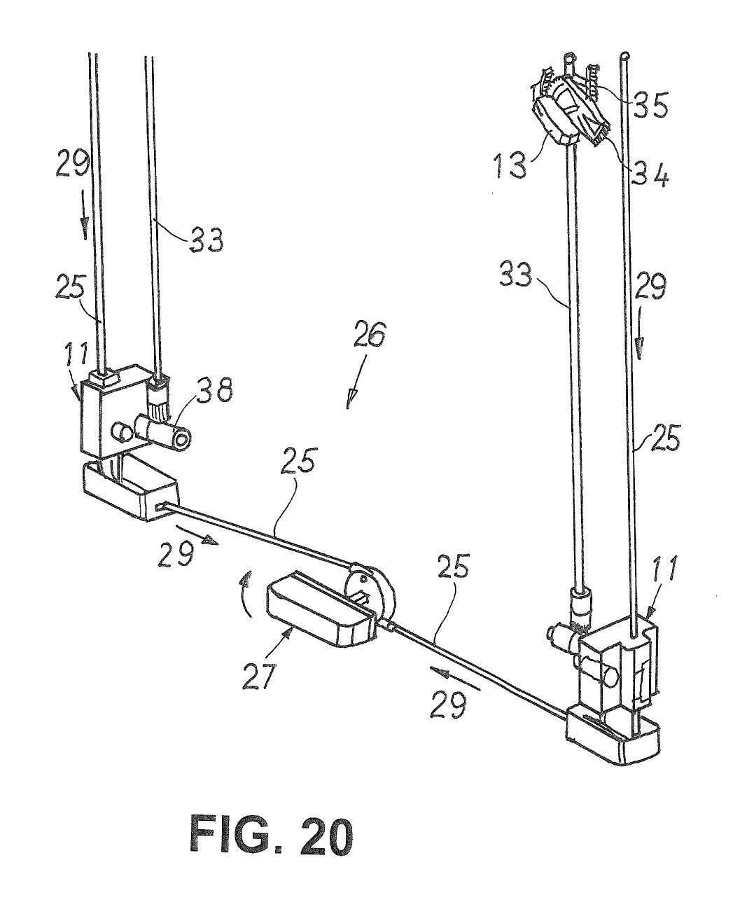

FIGS. 14-16 show the mechanism in exploded view and in cross-section, respectively,

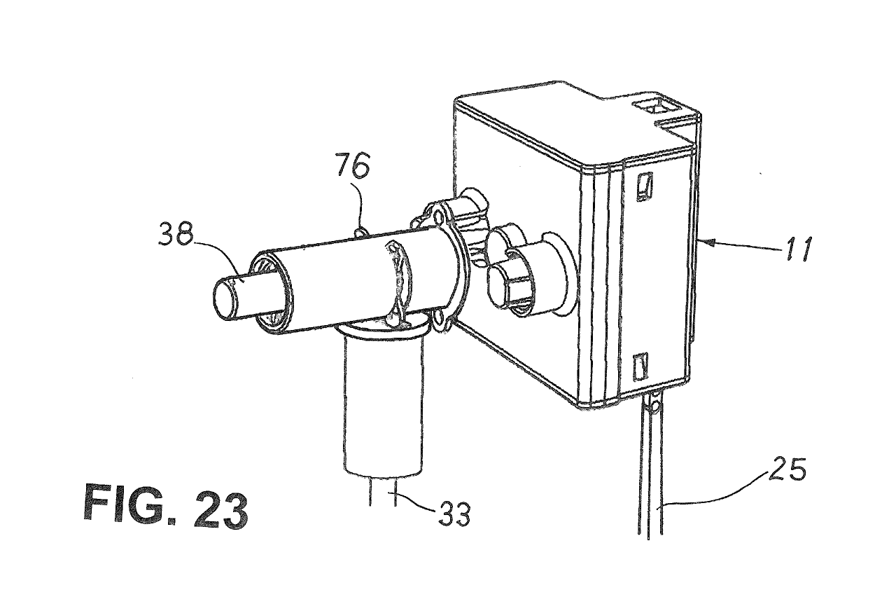

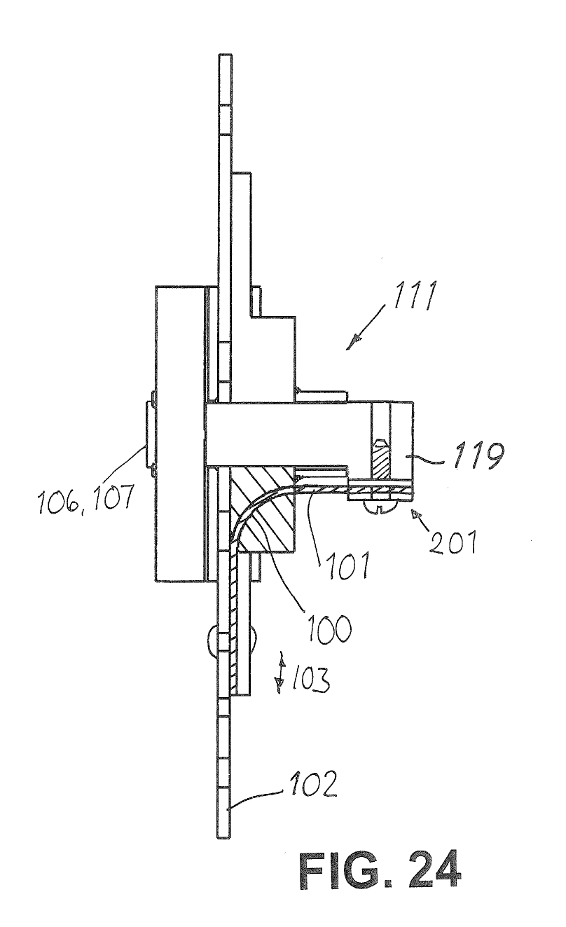

FIGS. 17-18 show a lock plunger in exploded view and in retracted position, respectively,

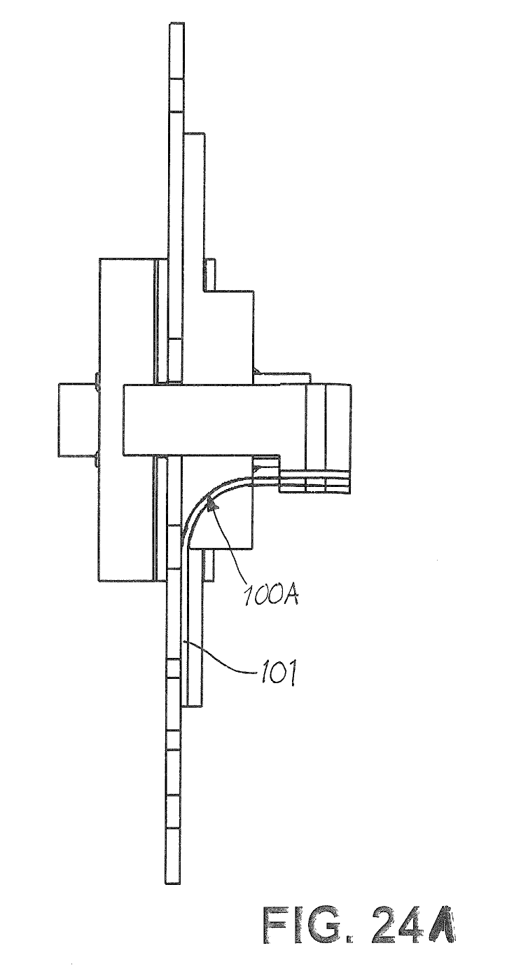

FIG. 19 shows in cross-section the mechanism in the window, in a position prepared for pivoting,

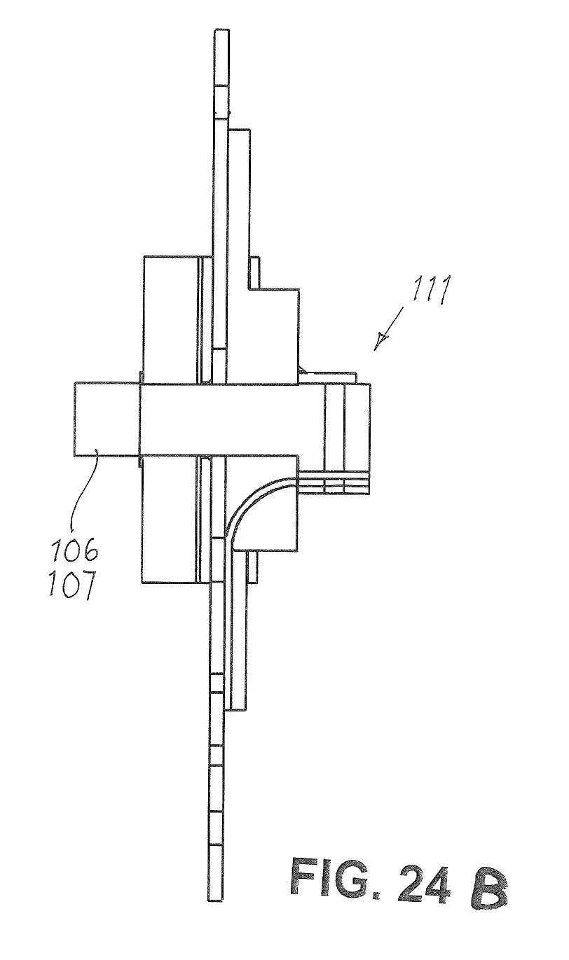

FIG. 20 shows in perspective actuation parts included in the mechanism,

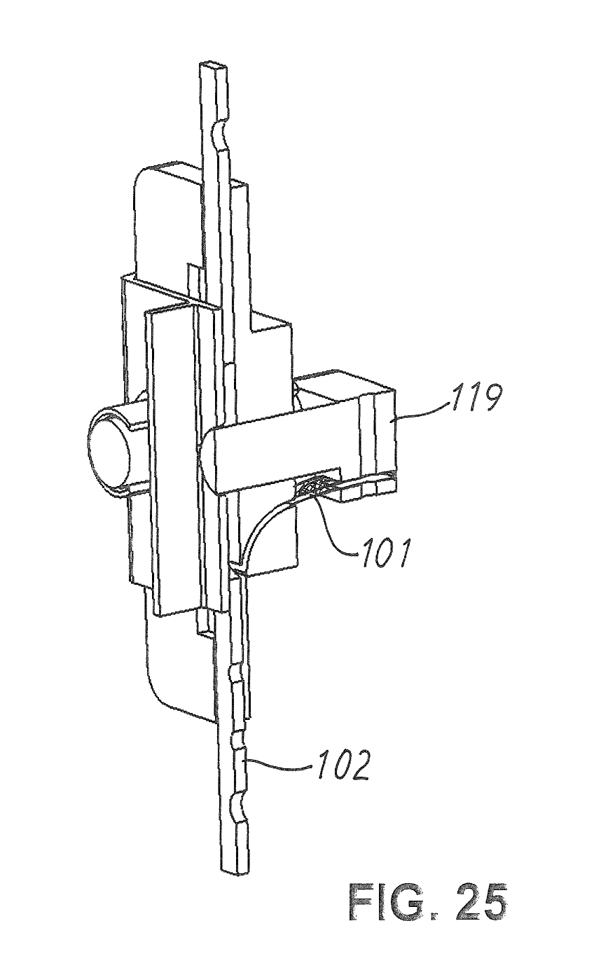

FIG. 21 shows a picture of the mechanism and the actuation pin thereof,

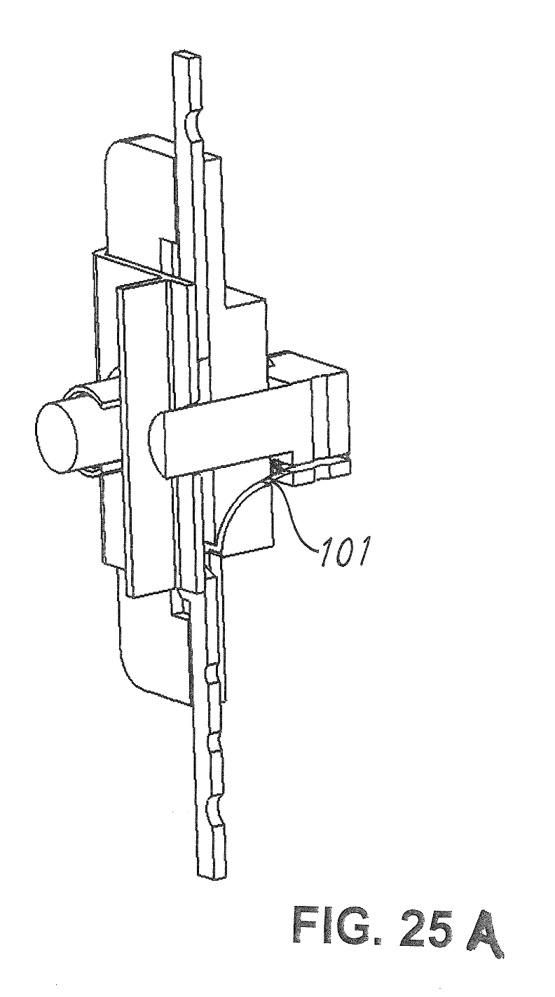

FIG. 22 shows the mechanism in position for the closing and locking of the window,

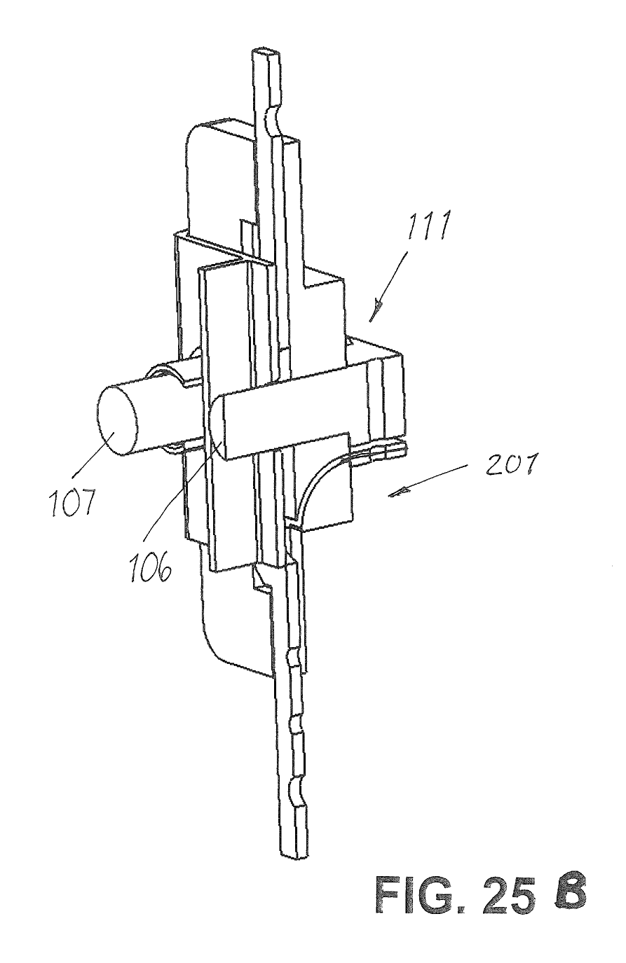

FIG. 23 shows the actuation pin in an arrested position prepared for activation,

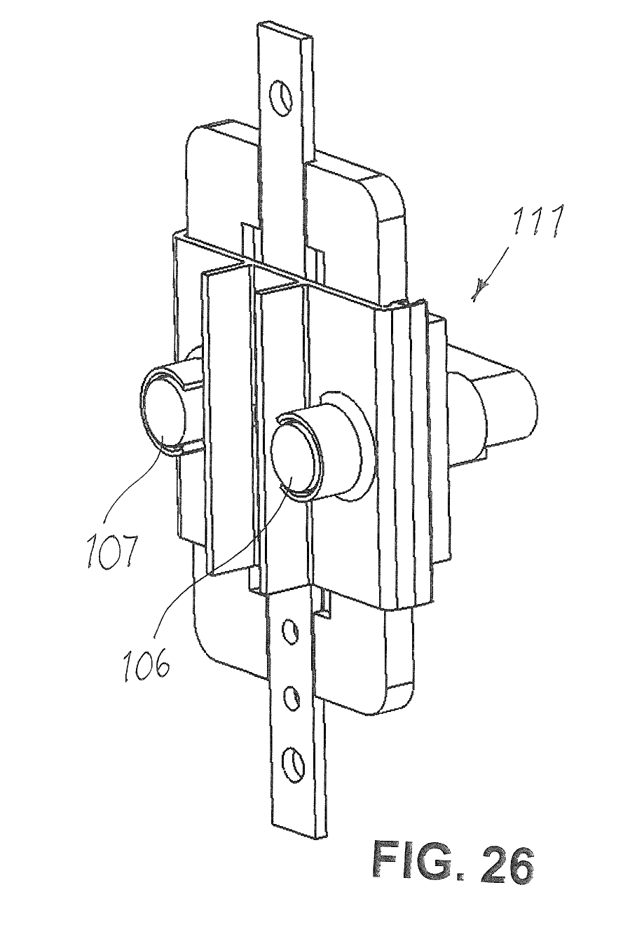

FIGS. 24-24B show section views of a control mechanism according to a further embodiment with an appurtenant motion transfer part,

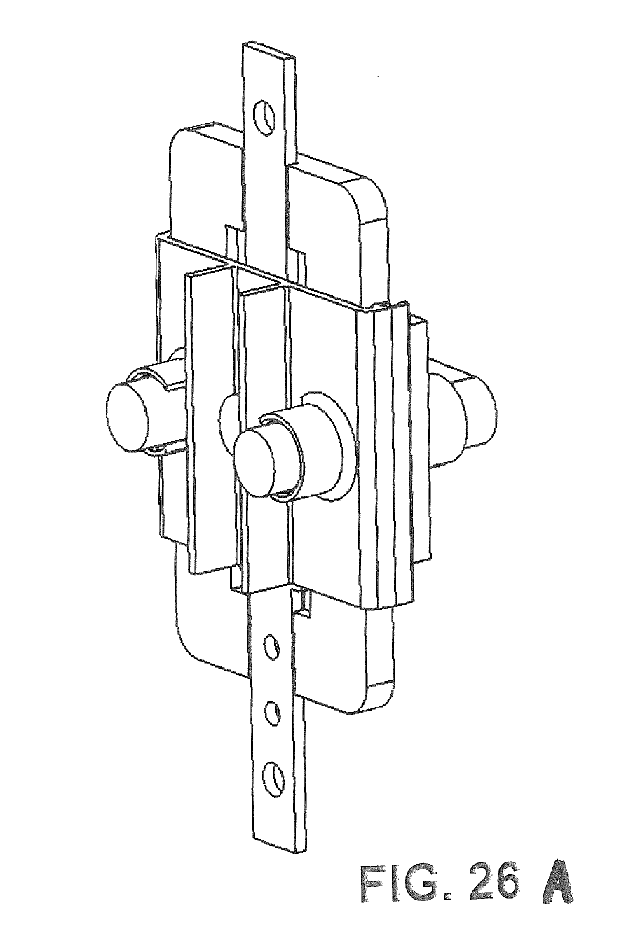

FIGS. 25-25B show in perspective and in cross-section said control mechanism and motion transfer part,

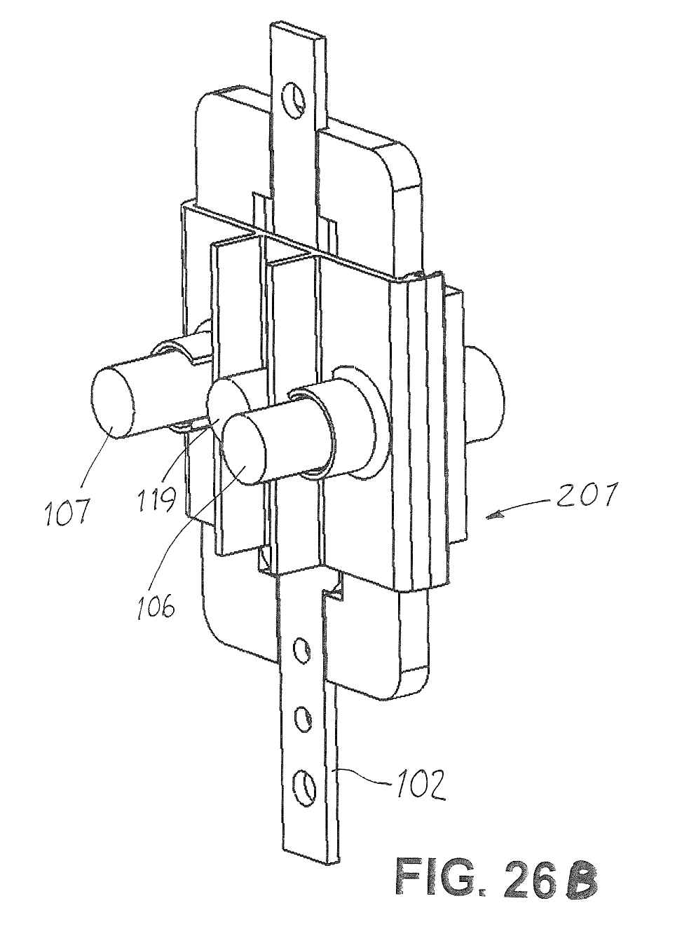

FIGS. 26-26B show perspective views of a control mechanism in different actuation positions,

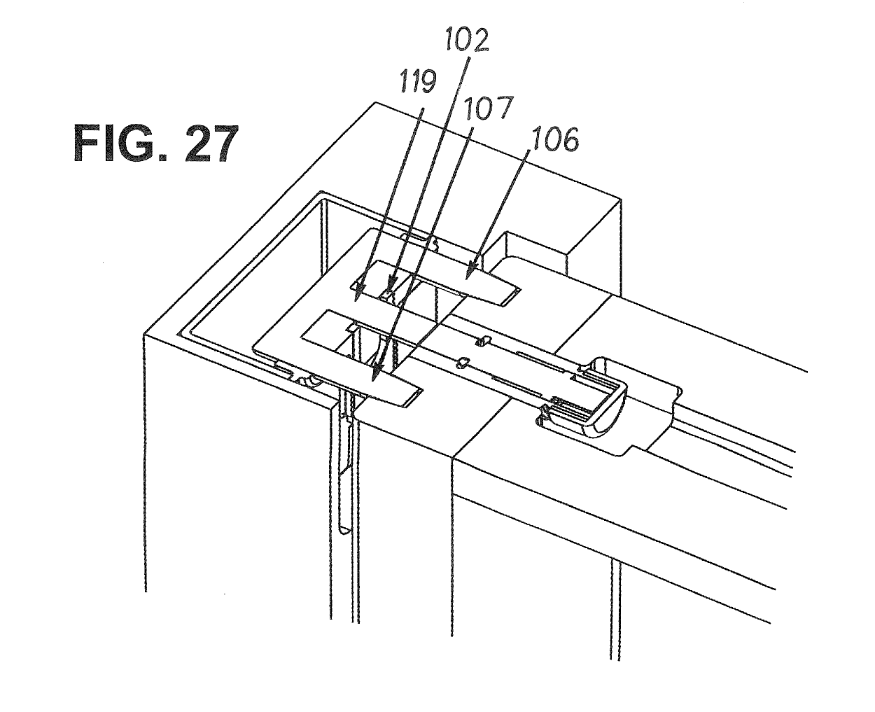

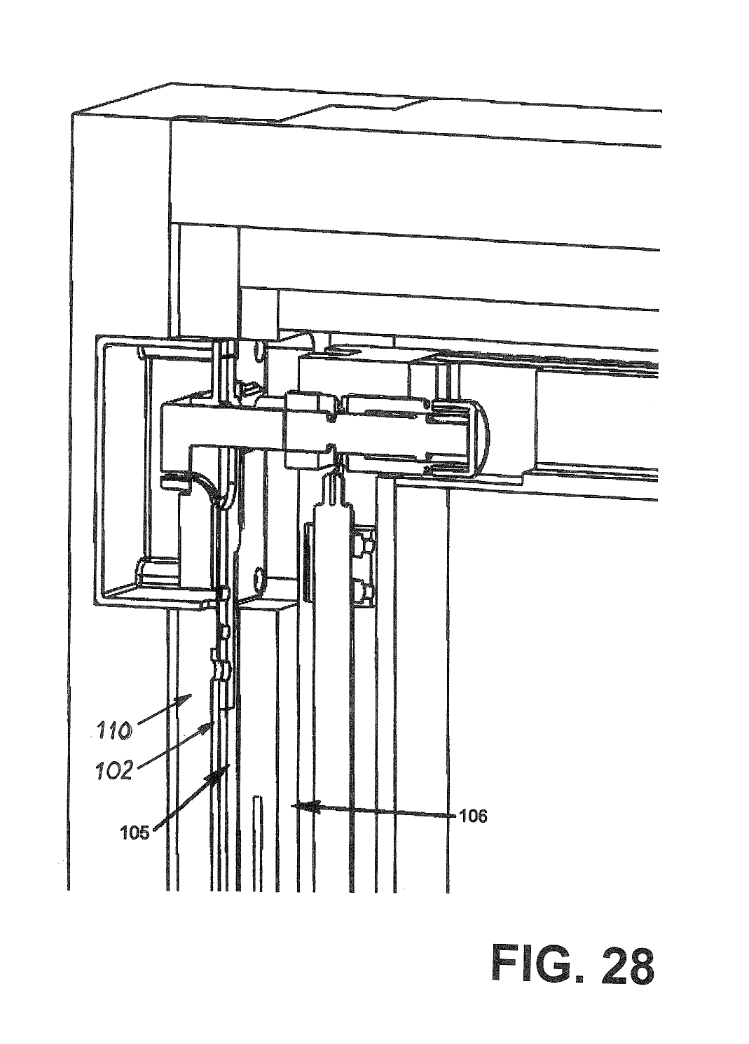

FIGS. 27-28 show in section views the control mechanism in an active regulation position, and

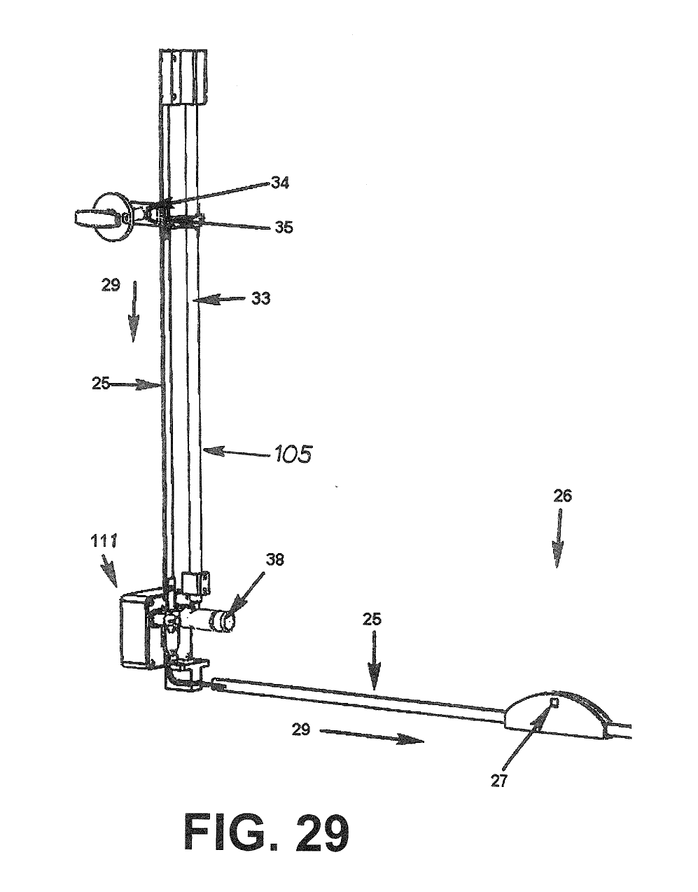

FIG. 29 shows a picture of a part of an elongate rail-shaped insertion cartridge comprising the entire mechanism for a window and its regulation.

A device 1 at an openable and turnable window 2, which comprises a window pane 4 received in a window casement 3 with the casement 3 and the pane 4 receivable in a common window frame 5, turnable 180° or more around a pivot bearing formed of pivoting arms 8, and secured in the frame 5 by means of a number of lock plungers 6, 7, which are receivable in guiding grooves 9, 10 in the window casement 3, comprises a number of control mechanisms 11, 23 in the frame 5 for the regulation of the motion of said lock plungers 6, 7.

According to the invention, in each corner A, B, C and D of said square-shaped frame 5, a control mechanism 11 is arranged for the regulation of the motion of said lock plungers 6, 7. A control 27 for the actuation of said lock plungers 6, 7 and the opening of the window in other respects is arranged on the window frame 5. The control mechanism 11 comprises a cam surface 14 that is co-operatable with a motion transfer part 19 actuating said lock plungers 6, 7. Said motion transfer part 19 is movable in relation to said cam surface 14 and compulsorily fixed to the same. Thereby, said part 19 can only be displaced along the cam surface 14 but not be distanced from the same. A said window casement 3 is optionally turnable and angleable, respectively, into the desired position as well as lockable in the closed position by the actuation of guide heads 38 by means of different controls 12 and 13, respectively, therefor.

Control mechanisms 23 may also be arranged in the vertical side portions 16, 17 of the frame at a distance from said cornered A-D control mechanisms 11. This applies particularly to large windows.

The control mechanism 11, 23 comprises at least one preferably pin-shaped lock plunger 6, 7 extending through a hole 18 in the frame 5. Said lock plunger 6, 7 is connected 15 with an actuation part 19 working as a motion transfer part which is arranged to compulsorily be displaced along the said cam surface 14. For said lock plungers 6, 7, said control mechanisms 11, 23 comprise a guided actuation part 19 compulsory movable along a leaning groove path 20. Said groove path 20 may be arranged with sliding or rolling connection 15 with a said actuation part 19.

In the drawings, it is clearly shown in FIG. 20 how a common control 26 for all control mechanisms 11, 23 is formed of a number of interconnected links 25, a wire or some other suitable pulling or pushing member, and that is jointly connected with said control mechanisms 11, 23 to provide the actuation thereof.

A rotatable handle 27, or another actuatable grip, that is placed at the bottom of the frame 5 along the horizontal part 28 thereof is connected to said control 26. Rotation of the handle 27 in one of the directions of rotation actuates the control 26 to move in one direction 29 while actuation of the handle 27 in the opposite direction of rotation provides the opposite direction of motion of the control 26. Thereby, the cam surface 14 of the respective control mechanism 11, 23 can be actuated to either move vertically upward 80 or downward 81 depending on in which direction the appurtenant handle 27 is actuated to rotate or in another way move, whereby the appurtenant lock plunger/lock plungers 6, 7 is/are actuated to move horizontally outward 90 and inward 91, respectively, from the appurtenant control mechanism 11, 23 and window 2.

Furthermore, in order to allow release of a respective guide head 38, different actuation handles 12, 13 are connected with a gear rack 33 via gear rack transmission 34, 35. Said actuation handles 12, 13 are situated on each side of the window casement 3, on the window frame 5.

Said lock plungers 6, 7 are preferably conical and received in likewise preferably conical grooves 9, 10 along the window casement 3. Said spring actuated 38A guide heads 38 received in the window casement 3 are arranged to, after activation, make that the window can be opened at the top or bottom, for example upon airing.

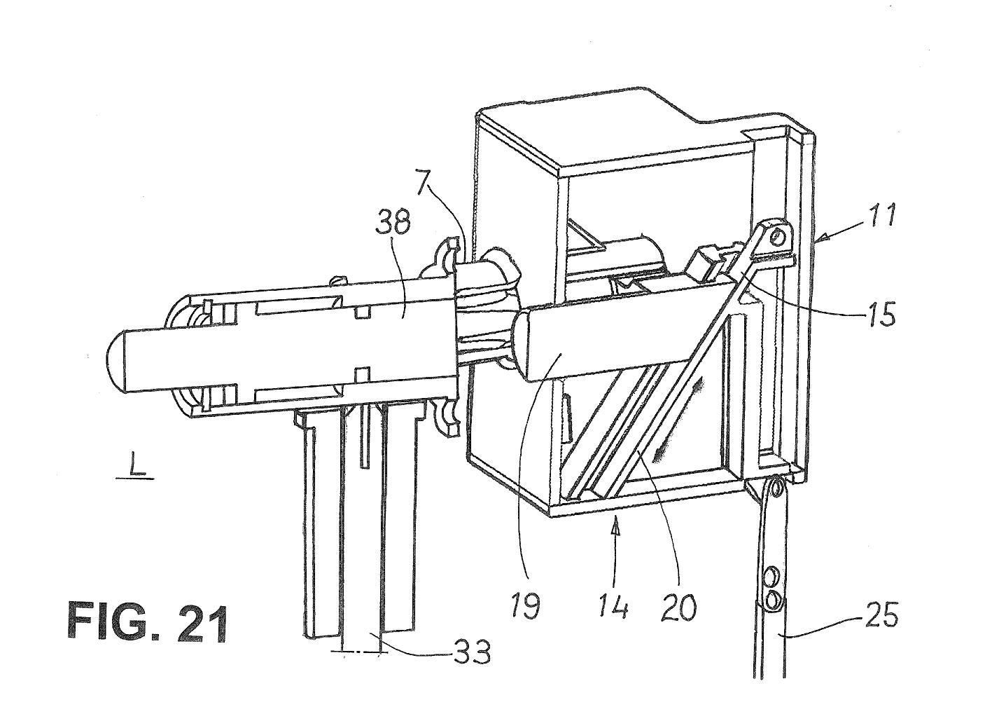

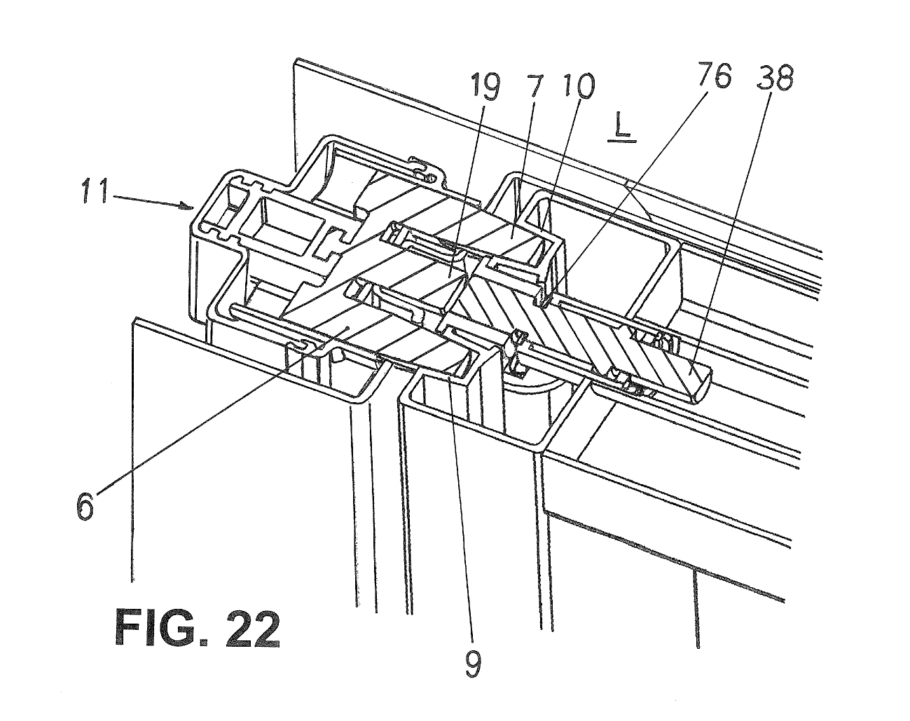

Both said frame 5 and casement 3 are formed of window sections consisting of plastic, metal or wood, or a combination thereof. Pair-wise lock plungers 6, 7 in said control mechanism 11, are aligned 40 with each other, as seen transversely to 41 the window 2, and between themselves, they have a connected actuation pin 19. In control mechanisms 23 having only one lock plunger 6 or 7, a similar motion transfer part 19 may be connected to only one lock plunger 6 or 7, for instance as shown in FIGS. 15-16. Other parts included in the invention preferably consist of metal materials, but may possibly consist of plastic materials.

The motion pattern of the window 2 is according to the following, as examples:

### Nominal Position—The Window is Closed and Locked

When the window is closed and locked, all lock plungers are inside the guiding grooves of the casement. All lock plungers are interlinked with the horizontal handle.
To release the lock plungers from the casement at the top/bottom, rotate the horizontal handle, e.g. 180°.
The lock plungers then slide into the frame and allow opening of the window.

### Turning/Airing Position

For airing at top/bottom or turning the window, rotate both vertical handles 180°. The respective guide head is locked in their inner position, which means that it cannot run out into the guiding groove in the frame.
In its unactuated position, the guide head is spring-loaded, which makes that it follows the motion of the lock plunger.
Turn around the window or only open it for airing if desired.
After turning of the window, rotate back the horizontal handle to lock the window.
If it is only desired to air in the position that the window is in, this is made rotating the horizontal handle 180°. Hence, the vertical handles require no actuation in this position.

According to the embodiment shown in the drawings in FIGS. 24-29, the device 201 shown thereby is formed of similar parts and function as the above-mentioned device 1 apart from the control mechanism 111. This is formed so that the cam surface is formed of one 100A of the sides of a groove 100 and that a motion transfer part consists of a bendable strip 101 or a similar element that is stiff in its longitudinal direction, at least in co-operation with said groove 100 and as seen in the length extension 103 of the strip. A control 27 and control mechanisms 11; 111, 23 are in that connection contained in a common box-shaped cassette 105 that is insertable in a mating elongate recess 110 in a said window frame of the window in question. The strip 101 is displaced along the groove 100 in co-operation with one side 100A thereof that in that connection forms a cam surface that co-operates with one flat broad side of the strip. In that connection, the strip 101 is connected with an elongate rail 102 the function and nature of which are according to the corresponding parts in said first embodiment example.

Thereby, among other things, simple mounting of the window is allowed.

The groove 100 has an even curvature and a portion of the strip 101 is displaced along the groove 100, as seen in the longitudinal direction of the strip. The groove 100 and the formed cam surface 100A thereof guide the strip 101 efficiently along the length extension of the groove 100, so that the strip is prevented from bending, and that the motion transfer part 119 interconnected with appurtenant lock plungers 106, 107 is displaced together with the motion of the strip in a similar way as described above according to the first embodiment example.

The function and nature of the device 101 are seen clearly from the drawings, where sequences of motion patterns of the mechanism 111 are shown clearly illustrated. Pulling the rack in the downward direction makes so that the lock plungers are pushed out into the active lock position, while the opposite occurs in the reverse direction of motion.

The nature of the invention and its clear-cut function should have been evident from what has been indicated above and by means of the drawings. Naturally, the invention is not limited to the embodiments described above and shown in the accompanying drawings. Modifications are feasible, particularly as for the nature of the different parts, or by using an equivalent technique, without departing from the protection area of the invention, such as it is defined in the claims. Accordingly, the invention is equally well suitable to apply to other similar covering elements, such as, e.g., openable filters and aircraft doors.

1.-13. (canceled)

14. A device for a casement window having a pane received in a casement with the casement and pane received in a frame, the casement being rotatable around a pivot bearing formed of pivoting arms and secured in the frame by a number of lock plungers received in guiding grooves in the casement, the device comprising:
in each of plural corners of the frame, a control mechanism configured for regulating motion of the lock plungers, and a control for actuating the lock plungers arranged on the window frame,
wherein the control mechanism comprises a cam surface that co-operates with a motion transfer part of the control actuating the lock plungers, and the motion transfer part is configured for moving in relation to the cam surface, whereby the casement is rotatable into a desired position and lockable in the desired position.

15. The device of claim 14, further comprising second control mechanisms each including a lock plunger arranged in side portions of the frame at a distance from the control mechanisms.

16. The device of claim 14, wherein the control mechanism comprises at least one pin-shaped lock plunger extending through a hole in the frame, and the lock plunger is connected with the motion transfer part that is arranged to be compulsorily displaced along the cam surface.

17. The device of claim 16, wherein the control comprises a sliding or rolling actuation part that is compulsorily movably guided along a curved or angled groove path for the lock plungers having sliding or rolling connection with the actuation part.

18. The device of claim 14, further comprising a common control for the control mechanisms, wherein the common control includes a number of pulling or pushing members that are connected with the control mechanisms, and the common control and control mechanisms are contained in a common cassette configured for insertion in a mating recess in the frame.

19. The device of claim 17, wherein the cam surface is formed of one side of a groove, and the motion transfer part comprises a bendable strip that is guided by and received in the groove.

20. The device of claim 19, wherein the groove has a smooth curvature, and the strip is connected with an elongate rail.

21. The device of claim 19, wherein the groove is formed as a flute that is shape-adapted to the strip and arranged in a frame of the control mechanism.

22. The device of claim 14, further comprising different actuation handles for locking and releasing, respectively, axially movable spring-force-actuated guide heads connected to a rack via a gear rack transmission; and a control is arranged via a gear rack to actuate a lock member to lock the guide head retracted in a lock position in a housing in the casement.

23. The device of claim 22, wherein the control is an actuation handle situated on a side of the casement on the frame.

24. The device of claim 14, wherein the lock plungers are substantially conical and arranged to be received in corresponding conical grooves along a height of the casement.

25. The device of claim 14, wherein the frame and casement are formed of plastic, metal, wood, or a combination thereof; pair-wise lock plungers in a control mechanism are aligned with each other transverse to the window and have between themselves a connected actuation pin; and the lock plungers and other parts of the respective control mechanism are formed of plastic, steel, or aluminum.

26. The device of claim 14, wherein the cam surface is movably actuatable.
